(19) United States
(12) Patent Application Publication
(10) Pub. No.: US 2008/0064422 A1
(43) Pub. Date: Mar. 13, 2008

(54) Method of Distributing a Message Via Short-Range Radio Networks

(75) Inventor: Holger Scholl, Herzogenrath (DE)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/575,523

(22) PCT Filed: Sep. 8, 2005
(86) PCT No.: PCT/IB05/52919

§ 371 Date: Mar. 19, 2007

(30) Foreign Application Priority Data
Sep. 24, 2004 (EP) 04104651.7

(51) Int. Cl. H04Q 7/20

(52) U.S. Cl. 455/466

(57) ABSTRACT

The present invention relates to a method and a communication unit to distribute a message (100) via short-range networks by means of relaying said message (100) from one short-range network device (104, 106) to the next (107, 109). The relevance of the message (100) is checked by comparing a distribution criteria (103) of the message (100) to a criterion associated with the devices (107, 109), wherein the message (100) is considered relevant when there is a match between said distribution criteria (103) and the criterion associated with the devices

The present invention relates to a method and a communication unit to distribute a message via short-range networks by means of relaying the message from one short-range network device to the next.

In normal long-range networks, each message is dedicated for a specific recipient or group of recipients that is identified by a physical address. Routers or transponders take up the messages and distribute them further to specific outside instances, or to destinations within their own sub-networks. Normally, only one active copy of a message is distributed further to a particular address. In most short-range networks, where the devices roam in (relatively) close distance to each other, or to transponder stations, a similar approach is adopted.

The problem with these long- and short-range networks is the limitation to the 1-to-1 relationship. This will have a very limiting effect to the many near-future mobile devices which will be equipped with short-range networking capabilities.

It is the object of the present invention to solve the above-mentioned problems.

According to one aspect, the present invention relates to a method of distributing a message via short-range networks by means of relaying said message from one short-range network device to the next, wherein at said devices the relevance of the message is checked by comparing a distribution criteria of said message to a criterion associated to said devices, wherein the message is considered relevant when there is a match between said distribution criteria and said criterion associated with said devices.

The message can thereby be relayed across some distance from one device to the next in a controlled way so that an approach of a larger area network is obtained. Also, the limitation to the 1-to-1 relationship is expanded to 1-to-n relationship, where n is the number of devices where the message is considered to be relevant. In the case where the message is considered to be relevant, the user of the device may approach the message, or the message may be displayed automatically for the user. If, on the other hand, the message is not considered to be relevant, the user of the device preferably does not notice anything. In both cases the message can be relayed further to the next device where this is repeated.

In an embodiment the distribution criteria further comprises relaying information and wherein at each of said devices said relaying information is compared to relaying information associated to said devices, wherein said message is relayed to the next device based on said comparison.

Thereby, the relaying between said devices is controllable by either allowing the relaying of the message or stopping said relaying. As an example, the relaying information may comprise an identification of a time period wherein said message should be relayed between said devices, wherein said relaying information is e.g. compared to the time at each device being the relaying information associated to the devices. Therefore if the relaying information indicates that the message is to be relayed e.g. until 18:00, then, the relaying is stopped, i.e. when the time at the devices and thereby relaying information associated to the device shows e.g. 18:01.

Another example of relaying information is the indication of an area in which the message is to be relayed. Therefore, e.g. all cars within said given area forward the message to the next car etc, until the message is received by a car outside said area. In this case, the relaying information associated to the devices, e.g. the cars, is the position of the cars, which may be determined using GPS system or similar system which detects the current position of the cars.

Another example of relaying information is an associated counter to the message in order to limiting the number of devices to which the message is to be sent. Therefore, as the message is relayed between said devices, the counter is increased by one until the final counter value has been reached. The message may e.g. be limited to 1000 devices, so when the message is relayed to device nr. 1000, the relaying is stopped. In this case the relaying information associated to the devices could be a specific number e.g. 0 and the relaying is performed until counter equals zero. It should be noted here that this requires that the relaying information is updated at each of the devices because of the update of the counter, whereas in the two previous examples, such an update is not necessary.

In an embodiment said message is generated by one of said short-range network devices.

Thereby, the message can be generated and relayed to other devices by the same device. The generated message can as an example comprise a traffic alert such as “icy road conditions”, wherein the message could be generated automatically through break-sensors. The output data from the sensors would be processed, whereby the type of sensor output data could define the distribution criteria automatically.

In an embodiment the distribution criteria comprises an identification of an area to which the message is to be sent.

Thereby, the message can be restricted to a specific area so that only the receivers in this area are considered relevant receivers of the message. The receivers could as an example be cars comprising a communication unit which is adapted to receive (and transmit) and display the message for the drivers. This message can comprise information about icy conditions on a road, a traffic jam, an accident, an environmental accident, etc. In this case the position of the message would preferably be attached to the message as distribution criteria, whereby e.g. all devices within a 50 km radius receive the message and consider it to be a relevant message. In this case the actual position of the devices determined by e.g. GPS is the criteria which is compared to the said distribution criteria.

In an embodiment the distribution criteria comprises the time of issue of said message.

Thereby, if the message which has been sent is old, it may not be considered relevant any longer. As an example, if the message comprises information relating to icy road conditions and the message is 3 hours old it would not be considered relevant any longer since it is too late to warn the driver.

In an embodiment the distribution criteria comprises an identification of a user group to which the message is to be sent.

Therefore, messages may be used for e.g. cultural or social purposes. In this case the devices which the users are provided with, e.g. mobile phones, have pre-defined criterions so that they receive all messages of this kind.

In an embodiment the distribution criteria comprises a combination of the distribution criteria from the group consisting of:

an identification of an area to which the message is to be sent,

the time of issue of said message, and

an identification of a user group to which the message is to be sent.

Thereby, more than one criterion may be attached to the message simultaneously. As an example, if the message comprises information relating to icy road conditions, it would be preferred that the distribution criteria would comprise data relating to the area along with the time of issue of the messages.

In a further aspect, the present invention relates to a computer readable medium having stored therein instructions for causing a processing unit to execute said method.

In another aspect, the present invention relates to a communication unit to be used in a short-range network device comprising a receiver for receiving a message and a processor for determining the relevance of said message by means of comparing a distribution criteria of said message to a criteria associated with said device, wherein the message is considered relevant when there is a match between said distribution criteria and said criteria associated with said device.

Thereby, a communication unit is provided which transmits or relays a message across some distance from one device to the next in a controlled way. It follows that the limitation to the 1-to-1 relationship is expanded to 1-to-n relationship, where n is the number of devices where the message is considered to be relevant.

In an embodiment the communication unit further comprises a transmitter for transmitting the message to another short-range network device.

Thereby, the communication unit can transmit the received messages to other short-range network devices.

In an embodiment the communication unit further comprises means for generating said message.

Thereby, a message can be generated and subsequently transmitted to other communication units.

In the following, the present invention, and in particular preferred embodiments thereof, will be described in more detail in connection with accompanying drawings in which

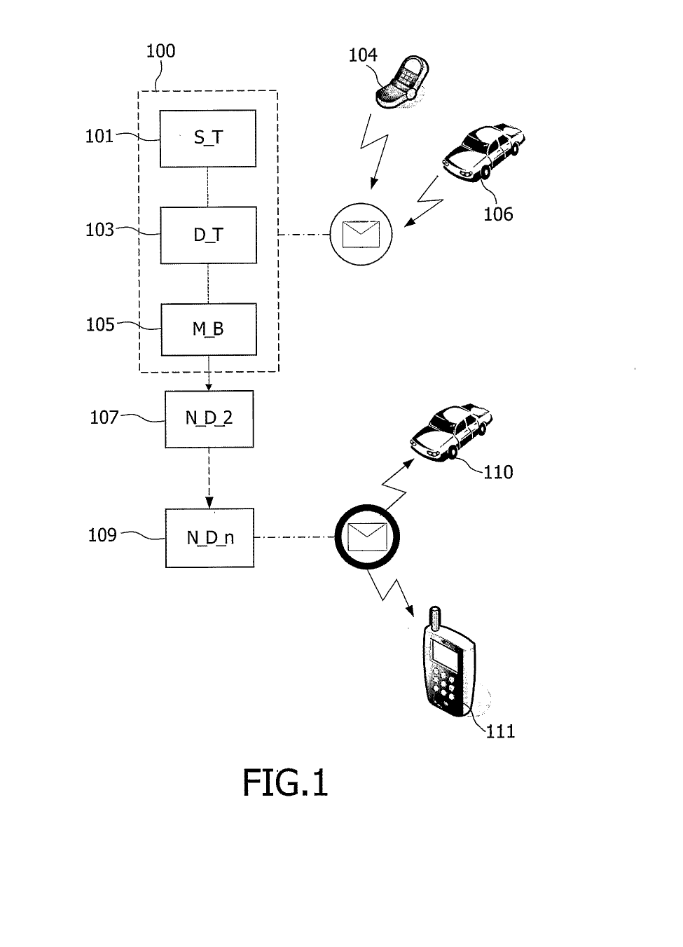

FIG. 1 shows a method of distributing a message via short-range networks by means of relaying said message from one short-range network device to the next,

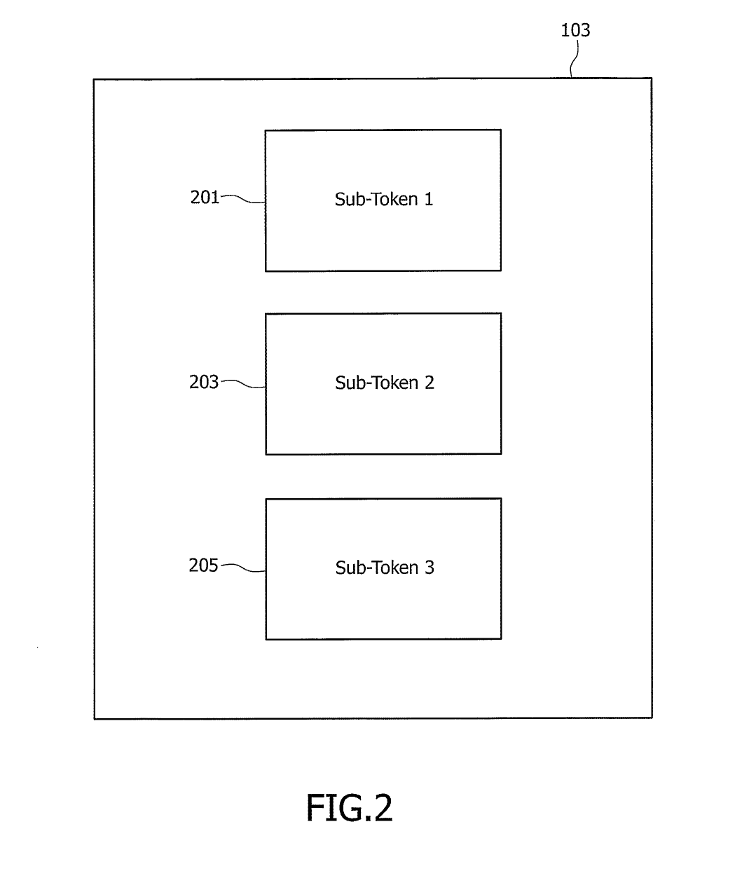

FIG. 2 shows one embodiment of a distribution token shown in FIG. 1,

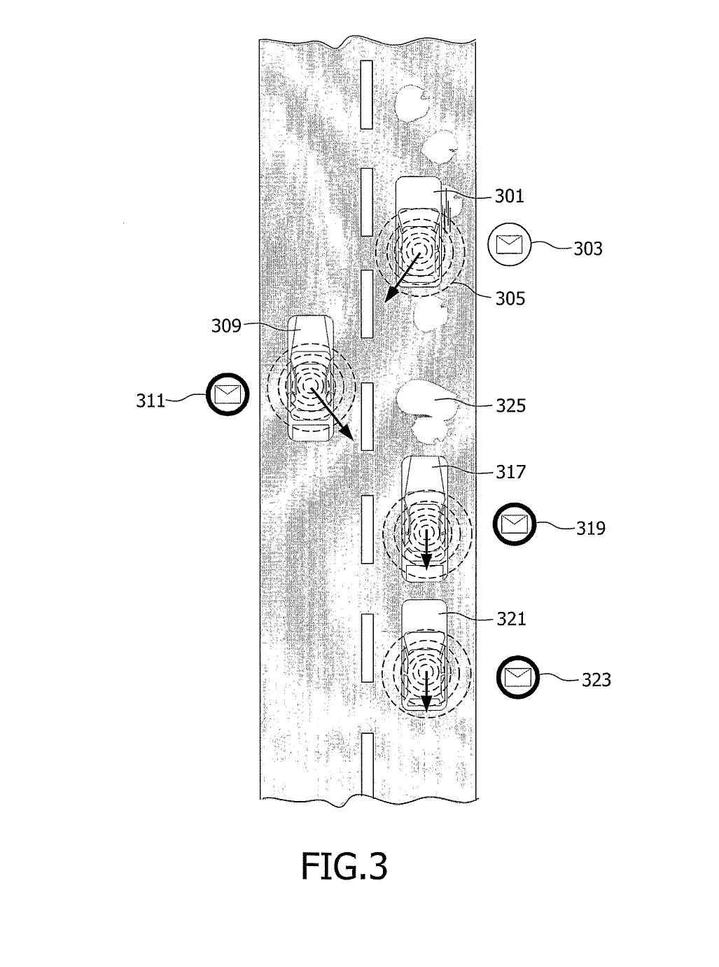

FIG. 3 shows one example of how to implement the method to transmit a message via short-range networks,

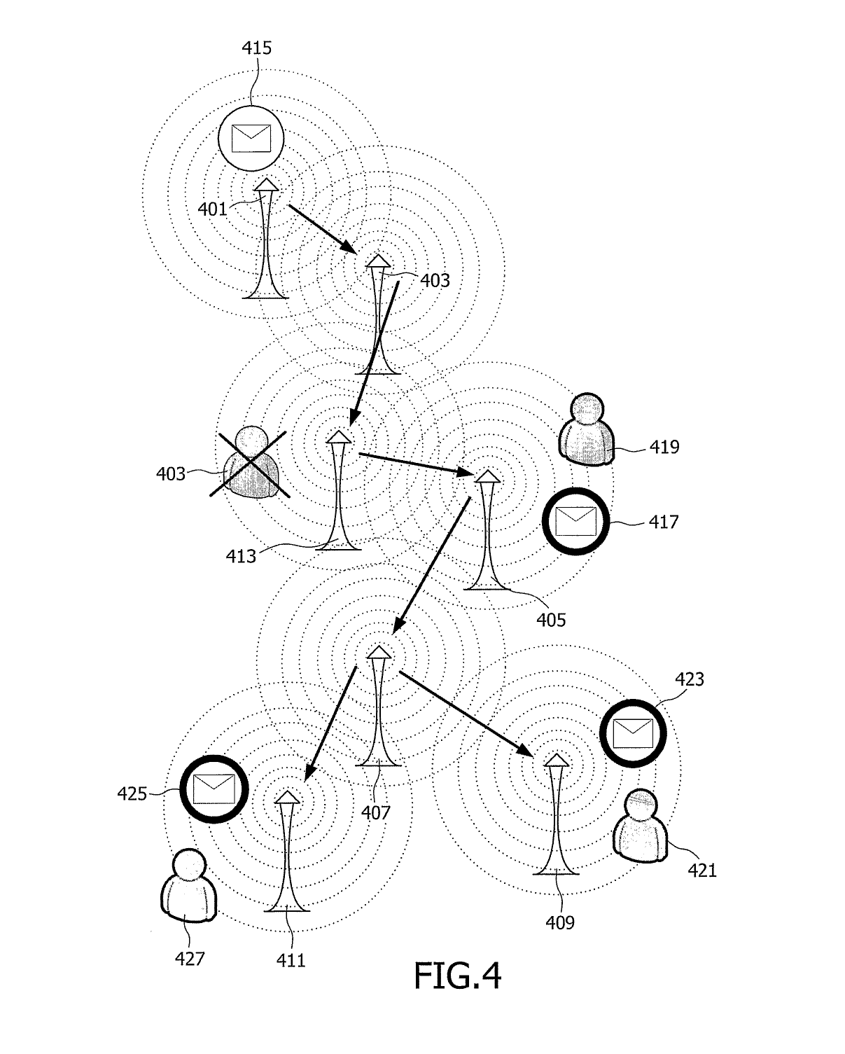

FIG. 4 shows another example of how to implement the method to transmit a message via short-range networks, and

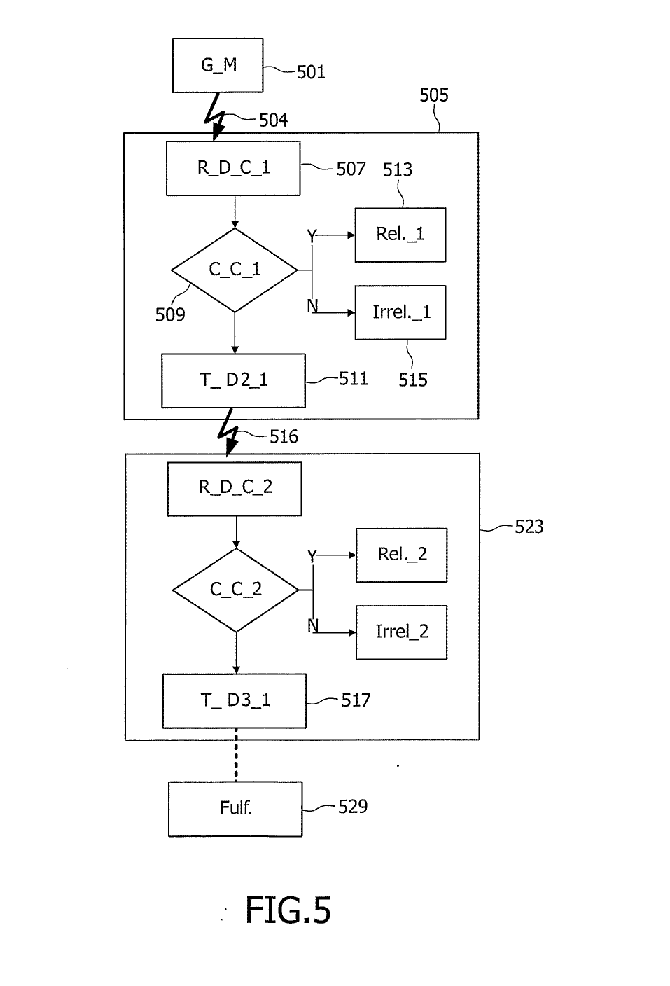

FIG. 5 shows a flowchart of an embodiment of a method to transmit a message via short-range networks.

FIG. 1 shows a method of distributing a message (100) via short-range networks by means of relaying said message (100) from one short-range network device (104, 106) to the next (N_D_2) 107, (N_D_n) 109. As illustrated here, the message 100 comprises three elements: a sender token (S_T) 101, a distribution token (D_T) 103 and a message body (M_B) 105. The sender token (S_T) 101 comprises preferably data related to who initiated the message and even the devices which have received the message 100. The distribution token (D_T) 103 comprises preferably distribution criteria, which will be discussed in more details under FIG. 2. Finally, the message body (M_B) 105 comprises preferably the content of the message, which e.g. can comprise traffic alerts or cultural or social information which is shared with others in a collaborative way.

The short-range network devices can be mobile phone 104, 111 or any other kind of a mobile device or a car-computer 106, 111 comprising a communication unit (not shown).

In one embodiment the communication unit comprises a transmitter and a receiver for transmitting and receiving such a message 100 and is further adapted to generate a message 100 of this type. As an example, if the content in the message body (M_B) 105 comprises traffic alerts such as “icy road conditions”, the message could e.g. be generated automatically through break-sensors or other sensors. The output data from the sensors would be processed by a processor of the communication unit, whereby the type of sensor output data would define the distribution criteria in the distribution token (D_T) 103. In this case it would be of essential importance that the distribution criteria comprises means for restricting the message body (M_B) 105 to a specific area, e.g. this particular road, and the time of issue of the message so that other communication units which receive the message can alert the drivers of the cars 110, 106 in due time.

Such a message body (M_B) 105 could of course also be generated manually by a user of such a short-range network device, e.g. a mobile phone 104, where the distribution criteria in the distribution token (D_T) 103 could be defined manually.

In one embodiment the communication unit comprises means for generating a message 100 and a transmitter for transmitting the message 100. As an example, the communication unit could be a sender or similar means which would be used for e.g. alerting drivers. The sender could further comprise several sensors for measuring e.g. the road temperature or various whether conditions where the output data would be processed by a processor of the communication unit. As mentioned earlier, the type of sensors output data could be used to define the distribution criteria in the distribution token (D_T) 103.

The sender could just as well be adapted to transmit a message 100 comprising e.g. cultural or social information to a group of people via said short-range network devices 107, 109, wherein the distribution criteria, which is attached to said message 100, would be compared to the criteria associated to each of said short-range network devices 107, 109. The criteria associated to each of said short-range network devices could e.g. be defined by the user manually or when the user purchases the device. As an example the user could be signed to a list for those who are interested in receiving said cultural or social information. Preferably, the message is considered relevant when there is a match between said distribution criteria and said criteria associated with each of said devices 107, 109, and the user may be notified Otherwise, the user will not notice that his/her device has received a message 100. Depending on whether or not the message 100 is considered to be relevant, it may preferably be transmitted further to other short-range network devices (N_D_2) 107, (N_D_n) 109, where this procedure is repeated. In this way the approach to a large area network is obtained by transmitting the message 100 between such short-range network devices 107, 109.

In one embodiment the communication unit comprises a receiver adapted to receive a message 100. In this embodiment the communication unit could be integrated into e.g. a car-computer and be adapted to display the message via the radio where different kinds of warnings could be displayed to the car driver. The warning could comprise: “slow down the speed, icy road ahead”. As mentioned earlier, the information could also be related to cultural or social activities.

It is of course important to control the relaying of the message between said devices 107, 109. Therefore, the distribution criterion comprises preferably relaying information e.g. in the distribution token (D_T) 103 for determining whether the message 100 should be further relayed or not, based on comparing with relaying information associated to the devices 107, 109.

FIG. 2 shows one embodiment of a distribution token (D_T) 103 shown in FIG. 1, comprising three sub-tokens 201, 203, 205, each comprising various token elements. Of course, the number of such sub-tokens can be different from three. The sub-tokens 201, 203, 205 could as an example comprise the following criteria:

Sub-token 201:

time and/or place of issue of the message:

exact time, year, month, day, hour, etc.

geographical coordinates,

relative to landmarks coordinates,

relative to other users coordinates,

postal address,

network identification address, and

mobile phone network cell of issue.

Sub-token 203:

region of interest of message:

time, time interval,

geographical area,

organizational “area” (e.g. building, company users),

users of special interest, and

users with special profile.

Sub-token 205:

parameters controlling a message's distribution:

max. or min. number of other users before receipt,

max. or min. number of other special interest users before receipt,

during time span since issue,

until point of time,

not before point in time, and

until leaving localization.

FIG. 3 shows one example of how to implement the method to transmit 305 a message 303 via short-range networks by means of relaying said message from one short-range network device to the next. In this example, the short-range network devices comprise a communication unit which is integrated into the cars 301, 309, 317, 321. A sensor unit in the first car 301 senses slippery or icy 325 conditions and automatically alerts the cars 309, 317, 321 which are driving the same road, or cars in the same area. The message 303 comprising the warning is sent via the short-range network devices, i.e. the cars 309, 317, 321, whereby each respective car receives the message 311, 319, 323 and forwards it to the next car. In each car the driver is alerted such as by displaying the warning in the radio of the car. For each respective car, the distribution criteria for the initial message 303 are preferably compared to a criteria in the communication unit in each respective car. As an example, a part of the distribution token (D_T) 103 in the message is the origin of where the message 303 is initiated or issued. This information would preferably be based on a Global Positioning System (GPS) in the car which would give exact data relating to the position of where the event occurred, along with the exact time of issue. These data or criteria would be compared to criteria in the neighboring cars 309, 317, 321, i.e. the GPS data and the time in the neighboring cars 309, 317, 321. In the case shown in FIG. 3, where the cars are all relatively close to the car 301 that initiates the message 303, the message is considered to be interesting. In this case, the criteria of time would even be compared to the actual time to check whether this event is old or new. The criteria in the initial message 303 could further comprise sending the message to all short-range network devices driving on road E45 and to a maximum of 5000 devices. Here we assume that the cars are provided with a navigation system or similar device.

FIG. 4 shows another example of how to implement the method to transmit a message 415 via short-range networks by means of relaying said message 415 from one short-range network device to the next 401, 403, 405, 407, 409, 411, 413. These devices may be any kind of mobile devices comprising a receiver, a transmitter, a processor and even a storage means having stored therein data relating to criteria to distinguish whether or not the message is relevant for the user by comparing the criteria to the distribution criteria of the message 415. In this case, the receiver of the message 415 is the one where there is a match between the distribution criteria and the criteria which is associated to said devices. As illustrated here, the message is considered to be relevant (marked as 417, 421, 427) to the persons or group of users 419, 421, 427, whereas for the user or a group of users 403 the message is not considered to be relevant. The user 403 would not notice that he/she has received a message 415, which as shown is forwarded further to the user 419.

The message can be initiated by a person (not shown) which e.g. has noticed that a special event has occurred, or automatically by the short-range network device 401.

FIG. 5 shows a flowchart of an embodiment of a method to transmit a message via short-range network devices. Initially the message is generated (G_M) 501 where a distribution token and a message body are defined. The distribution token defines the distribution criteria of the message, i.e. who should receive the message, and the message body defines the content of the message. As illustrated here, the message is transmitted 504 to a first short-range network device 505 where the distribution criteria of the message is read (R_D_C_1) and compared to criteria associated with the network device 505. The network device may be pre-programmed in a way that certain criteria are defined and preferably stored in a storage means. This definition may be done e.g. by the user of the device, or when the device is purchased. A processor of the network device 505 compares said criteria (C_C_1) 509 with said pre-stored criteria. If there is a match between the distribution criteria of the message and the pre-stored criteria, the message is considered to be relevant (Rel._1) 513 and is displayed to the user. The message is otherwise considered irrelevant (Irrel._1) 515. Subsequently, the message is transmitted (T_D2_1) 516 to a second short-range network device 523 where these steps are repeated, and where the message (G_M) 501 is subsequently transmitted (T_D3_2) 516 to a third short-range network device 523, etc. This is continued (repeated) until one or more distribution criteria of the message are fulfilled (Fulf.) 529. As an example, this can comprise the number of devices to which the message should be transmitted. By transmitting the message (G_M) 501 in this way between short-range network devices, the approach of a viral larger area network is obtained.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The word ‘comprising’ does not exclude the presence of other elements or steps than those listed in a claim. The invention can be implemented by means of hardware comprising several distinct elements and by means of a suitably programmed computer. In a device claim enumerating several means, several of these means can be embodied by one and the same item of hardware. The mere fact that certain measures are recited in mutually different, dependent claims does not indicate that a combination of these measures cannot be used to advantage.

1. A method of distributing a message (100) via short-range networks by means of relaying said message (100) from one short-range network device (104, 106) to the next (107, 109), wherein at said devices (107, 109) the relevance of the message (100) is checked by comparing a distribution criteria (103) of said message (100) to a criterion associated to said devices (107, 109), wherein the message (100) is considered relevant when there is a match between said distribution criteria (103) and said criterion associated with said devices.

2. A method according to claim 1, wherein the distribution criteria further comprises relaying information and wherein at each of said devices (107,109) said relaying information is compared to relaying information associated to said devices (107,109), wherein said message is relayed to the next device based on said comparison.

3. A method according to claim 1, wherein said message (100) is generated by one of said short-range network devices (104, 106).

4. A method according to claim 1, wherein the distribution criteria (103) comprises an identification of an area to which the message (100) is to be sent.

5. A method according to claim 1, wherein the distribution criteria (103) comprises the time of issue of said message (100).

6. A method according to claim 1, wherein the distribution criteria comprises an identification of a user group (419, 421, 427) to which the message (100) is to be sent.

7. A method according to claim 1, wherein the distribution criteria (100) comprises a combination of the distribution criteria (103) from the group consisting of:
an identification of an area to which the message (100) is to be sent,
the time of issue of said message (100), and
an identification of a user group (419, 421, 427) to which the message (100) is to be sent.

8. A computer readable medium having stored therein instructions for causing a processing unit to execute method of claim 1.

9. A communication unit to be used in a short-range network device (110, 111) comprising a receiver for receiving a message (100) and a processor for determining the relevance of said message (100) by means of comparing a distribution criteria (103) of said message (100) to a criteria associated with said device (107, 109), wherein the message (100) is considered relevant when there is a match between said distribution criteria (103) and said criteria associated with said device (107, 109).

10. A communication unit according to claim 9, further comprising a transmitter for transmitting the message (100) further to another short-range network device (107, 109).

11. A communication unit according to claim 9, further comprising means for generating said message (100).
